(19) United States
(12) Patent Application Publication
(10) Pub. No.: US 2002/0147678 A1
(43) Pub. Date: Oct. 10, 2002

(54) Adjudication method and system

(75) Inventor: Thomas S. Drunsic, Norton, MA (US)

Correspondence Address: Charles H. Dougherty, Jr., Esquire, Reed Smith LLP, P.O. Box 488, Pittsburgh, PA, 15230-0488, US

(73) Assignee: Mellon Bank, N.A.

(21) Appl. No.: 09/776,524

(22) Filed: Feb. 2, 2001

(51) Int. Cl. G06F 17/60

(52) U.S. Cl. 705/39

(57) ABSTRACT

An debit-card system for accessing funds in a participants Flexible Spending Account is provided. A method is provided that substantially eliminates the paperwork component of claims processing, and assures substantial compliance with the IRS rules. The debit-card system and method provide a virtually seamless transaction between the participant and the service provider. Compliance is accomplished through the creation of a sponsor shadow account that mirrors each sponsor's group account. Transactions are posted to the sponsor shadow account pending adjudication. Upon approval as a qualified expense, the transaction amount will be removed from the sponsor shadow account and posted to the individual participant's FSA. In this way, non-qualified expenses should never be posted to the participant's FSA, thereby substantially eliminating the potential risks and penalty for both plan sponsors and plan participants.

### BACKGROUND OF THE INVENTION

1. Field of the Invention

This invention relates generally to a method and system for adjudicating payment to an account, and more specifically, for posting payments to a specially qualified account in such a way so as to assure compliance and substantially alleviate the risk of incurring an IRS penalty for improper posting.

2. Background Information

Flexible Spending Accounts (“FSA's”) are authorized by the Internal Revenue Service (IRS Section 125). FSA's are a way for participants to pay out-of-pocket qualified medical expenses and dependent care expenses on a pre-tax basis.

Contributions to FSA's are funded by deductions from an employee's paycheck and are exempt from federal income tax, state income tax and social security tax. These contributions are deducted from the employee's paycheck before taxes are calculated, so the money goes into the FSA tax-free. Furthermore, no taxes are paid when money comes out of the FSA to reimburse the employee for qualified expenses. These features reduce the employee's taxable income reported on their W-2 form and also reduce the amount of payroll tax that the employer must pay.

Flexible Spending Accounts can save an individual participant (depending on their tax bracket) from 25%-40% of each dollar they spend on insurance deductibles, co-pays, or other qualified expenditures not covered by insurance. FSA participants can use their pre-tax dollars to pay for unreimbursed health-care expenses. Employees may also direct some of their FSA contributions to cover dependent care costs, such as daycare bills for their children or adult care expenses for aged parents.

The following are examples of qualified expenses that can be reimbursed to plan participants from FSA funds:

Deductibles, co-pays or coinsurance not covered by the participant's health insurance plan;

Expenses for diagnosis, treatment, cure or prevention of disease, if prescribed by a physician;

Prescription drug expenses;

Orthodontia if not for cosmetic purposes;

Medical expenses for hearing aids or vision care, (excluding premiums for contact lens replacement insurance or expenses for contact lens solution);

Expenses paid to a chiropractic or Christian Science practitioner;

The care of dependent children under age 13 by a babysitter;

Daycare center expenses; and,

Expenses in a before-school or after-school program.

Goods or services not explicitly qualified under the IRS rules, may not be paid with FSA funds and include, for example:

Contributions to other employer-sponsored medical or dental plans (contributions to the company's health plans are already made on a before-tax basis);

Costs deducted as health-care expenses on federal income tax returns;

Expenses not eligible to be deducted from federal income tax returns;

Expenses reimbursed by another health plan;

Health club membership dues;

Cosmetic surgery (e.g., electrolysis, hair removal or transplants, liposuction);

Nonprescription medications and vitamins;

Prescription drugs that are not medically necessary (e.g., Rogaine or Retin-A);

Cosmetic dental work (including bleaching, bonding and veneers);

Undocumented travel to or from a physician's office or other medical facility;

Weight loss programs;

Smoking cessation programs; and,

Long-term care services.

The FSA process generally works as follows: an employee/participant designates a pre-tax portion of their paycheck to be debited each pay cycle and these funds are held in a special savings account (typically set up at a bank or investment house); the participant receives and pays for goods or services and submits a request for reimbursement; and, the employee is reimbursed from his or her own special account for qualified expenses as they are requested and documented.

Like everything connected with the world of health-care, FSA's are not perfect. For example, employees typically must pay for their medical expenses with their own out-of-pocket funds and then file claim forms and receipts with the plan administrator to obtain reimbursement from their account.

For example, with reference to FIG. 1, the typical “front-end” process begins when an FSA participant 10 receives goods and/or services 40 from a provider 30. The participant makes payment 20 for the goods and/or services received with their own funds. This “out-of-pocket” payment may be accomplished by proffering cash, check, credit card, bank debit-card or any other form of legal tender. Upon completion of this transaction, the FSA participant has to procure reimbursement from his FSA.

With reference to FIG. 2, a common scheme of reimbursement is presented wherein the FSA participant 10 submits a request for reimbursement 50. This request for reimbursement is typically in the manner of a paper form and includes supporting documentation such as a copy of the bill and a receipt for payment to the provider. Upon receiving a request for reimbursement 50, the plan administrator 60 will evaluate this request and either reject 70 the request and notify the participant or approve 80 the request. Upon approval, the participant's FSA will be debited 90 and a reimbursement check will be sent 100 to the FSA participant 10.

Another example that is even more daunting than the paper work required to comply with the FSA process, are the financial risks and penalties for non-compliance. From an employee's standpoint, one of the biggest financial risks is the “use it or lose it” feature wherein participants forfeit their FSA contributions that are not used during the plan year. If, by the end of the plan year, the total withheld from the participant's paycheck is more than he or she has spent to cover his or her family's FSA-qualified expenses (and submitted for reimbursement), then the employer gets to keep whatever is left in the savings account. This prospect prevents many of the employees who could participate in FSA plans from taking advantage of the available tax savings. Furthermore, contributions to an FSA may not increase, decrease or stop once initiated unless there is a qualified change in family status (e.g., marriage, divorce or the birth of a child). Statistics suggest that fewer than 20% of the employees who are eligible to sign up for FSA's currently do so.

Low participation in FSA's is a problem, since companies (sponsors) need good participation levels if they're to earn significant payroll-tax savings and keep their plans in compliance with IRS rules. Like many pre-tax savings plans, top heavy participation by higher paid staffers is restricted based upon participation by lower paid employees. The “use it or lose it” aspects of FSA's cause employees to be conservative when projecting their anticipated qualified expenses for the year ahead. Employees have found that if they're cautious when making projections, they seldom face any real financial risk. Most employees who do participate in FSA's, as a consequence, under-designate the amount that they could actually shelter from taxes. This phenomenon also works to the plan sponsor's detriment because the employer invariably pays higher payroll taxes than it otherwise would if its employees participated in FSA's to their maximal capability. For example, employers can currently lower FICA taxes by $76.50 for every $1,000 that its employees direct into FSA's.

From a business owner's viewpoint, another problem with FSA's is that the company must cover any discrepancy between the amount an employee has promised to contribute during the course of the whole year and whatever funds actually have been set aside at the time he or she submits a request for reimbursement. For example, if an employee designates $1,800 to be set aside annually in their FSA (i.e., $150 to be deducted from each paycheck, assuming they are paid monthly) but has only accumulated $150 by the time a family member needs a qualifying procedure costing $1500 that is not covered by health insurance, the company must make up the $1,350 difference and hope that the employee doesn't quit before the employee has made adequate contributions to their account to cover the discrepancy. If the employee does quit, current IRS rules state that the company must absorb the loss. For both large and small companies, these carrying costs could be significant and may effectively eliminate any tax benefits for employers with a high rate of employee turnover.

One way companies minimize this particular risk is to set conservative limits on how much they allow employees to designate to their FSA. While current federal guidelines don't put a cap on the amount that employees can contribute to FSA plans for non-covered health-care expenses, companies typically set a conservative limit on employee contributions to alleviate this risk. Like the “use it or lose it” aspects discussed above, capping employee contributions to FSA's also works against the interest of both the sponsor and the participants by limiting the tax advantages available.

How Flexible Spending Accounts Work

Companies that offer cafeteria-type benefit programs to their employees generally have a process that employees go through to make their individual selections. Typically, each year during an open enrollment period, employees are given the opportunity to participate in a variety of voluntary benefit programs. The FSA is one program that is commonly included. Employees that decide to participate in FSA's generally need to first complete an election form identifying the amount of pre-tax salary that they wish to have set aside each pay period.

After selecting the amount of pre-tax salary that he or she wishes to contribute to the FSA for the year, the employee must submit a signed authorization to the employer instructing it to make the requested pre-tax deduction. These payroll deductions are placed into individual spending accounts (FSA's) for each employee as they are accumulated for each pay period during the plan year.

Upon incurring an eligible expense, one current practice is to have the employee submit a claim form to the spending account administrator requesting reimbursement of the expenses from the spending account. Most spending account administrators require that the claim form be accompanied by documentation to support the claim (i.e., receipts) that identify the service provider's name, the dates of the service, a description of the service and/or name of the medication and the total amount of your claim. This documentation is required in an attempt to avoid posting ineligible expenses to the spending account. Generally, claims may be submitted any time during the plan year, and for a reasonable period of time thereafter, typically 90-120 days after the end of the plan year for reimbursable expenses that were incurred during the plan year.

Upon receipt of an employee's claim for reimbursement, the spending account administrator will review the underlying transaction and documentation for compliance and issue a check to the employee in the amount of the claim drawn from the funds (i.e., the tax-free money) in the employee's spending account. Some plans have stipulated a minimum reimbursement amount whereby the spending account administrator will not issue the participant a check until the minimum claim amount has been accumulated. This can be a problem if the minimum claim amount set by the spending account administrator is higher than the typical co-pay that the participant must contribute when receiving medical services.

Although cafeteria plans (e.g., plans that include a variety of healthcare choices such as flexible spending accounts, medical savings accounts, dependent care accounts and different levels of medical and dental coverage) offer significant financial benefits to both employers and employees, but the paperwork associated with them is often confusing and overwhelming. This circumstance alone can discourage smaller companies from offering such plans to their employees. The amount of paperwork also serves to decrease maximal effective participation by employees who do have these plans available. A large percentage of employees simply don't want to be bothered regardless of the financial benefit. In their estimate, the reward doesn't justify the hassle.

One recent approach to addressing the paperwork hassles associated with FSA's has been to supply participants with a debit-card that is tied to their FSA. A debit-card simplifies the process for individuals holding funds in FSA's. The card may also be used to access Dependant Care Account funds (DCA's). A debit-card may significantly reduce the time, costs, and administrative burdens on employees, plan sponsors and plan administrators.

Debit-cards are tied or directed to a specific account, such as a savings account, checking account or, in this case, an FSA. Credit cards, on the other hand, are tied or directed to the cardholder's line of credit. In the case of debit-cards, the funds in the related account are finite, with the expenditure limit determined by the account balance. Credit card spending limits are also finite and are determined by the cardholder's credit limit and the terms of their cardholder agreement.

Some of the advantages of providing debit-cards that are tied to FSA's include:

Employees have instant electronic access to funds in their FSA's through a well established debit-card network;

There are no out-of-pocket expenses for employees;

Merchants and providers are paid at the point-of-sale

Administrators get a real-time processing tool;

Burdensome paperwork is reduced for the employee, the plan sponsor and the plan administrator; and,

Employee participation should increase, thereby reducing the employer's monthly payroll tax.

It is perhaps this last feature that provides the greatest incentive for an employer to offer its employees FSA debit-cards and to underwrite the credit exposure for accounts that are not fully funded until year-end. As mentioned previously, when there is a discrepancy between the amount an individual employee submits as a qualified FSA expenditure, and the individual employee's current FSA account balance, the employer must cover the difference. It seems logical that as more employees participate in FSA programs, the sponsor's pool of funds (i.e., the employer's running group account balance) should increase, and thereby reduce the need to fund any one participant's FSA expenditures with “borrowed” funds. This, in turn, works to minimize the carrying costs and associated risks for the employer/sponsor.

FSA debit-cards can be utilized just like any other debit-card. Participants merely need to present their card for payment at the time that goods or services are received (i.e., at the point-of-sale). It has been estimated that over 90% of goods and service providers accept debit-cards for payment, and merchants appear to prefer this type of payment. Furthermore, there is no minimum claim amount for each transaction, and no paperwork is required by the cardholder. Using a debit-card that is tied to an FSA is both an elegant and seamless solution to many of the problems currently encountered by FSA participants.

One company that offers such a solution is Med-i-Bank, Inc. (“mbi”) through its Flex Convenience™card system. Even though debit-cards like mbi's improve the front-end portion of the transaction (i.e., the exchange between the FSA participant and the provider), many of the problems that cause employers not to offer FSA's to their employees have to do with the financial risks associated with the backroom portion of the transaction. Specifically, a fail-safe method and system of screening expenses before posting them to the participant's FSA is absent; consequently the associated risks have not been adequately addressed by current debit-card plans.

It is a violation of IRS regulations to post a non-qualified expense to a participant's FSA. Under a traditional reimbursement process, a plan administrator avoids this violation by requiring participants to spend their own out-of-pocket money, submit a request for reimbursement, and provide receipts documenting the expense. Under recent debit-card schemes, the plan administrator adjudicates (screens) the transaction based upon the “merchant category code” of the service provider. A merchant category code is a classification system developed by Mastercard™ and Visa™ as can bee seen from Table 1 below.

TABLE 1

| MCC | MCC DESCRIPTION |
|---|---|
| 5713 | Floor Covering Stores |
| 5722 | Household Appliance Stores |
| 5732 | Electronic Sales |
| 5734 | Computer Software Stores |
| 5912 | Drug Stores, Pharmacies |

Merchant category codes are assigned to merchants based upon the type of goods they sell or services they offer. In this way, transactions that take place with a provider having a proper merchant category code are automatically passed through the adjudication process and posted directly to the participant's FSA.

This can be an effective adjudication as long as the merchant is coded as a health care provider and is a doctor or hospital. This method of adjudication becomes problematic, however, when the provider offers both qualified and non-qualified goods and services but is identified by a qualified merchant category code. For example, a participant may choose to have a prescription filled at a retail location that not only has a pharmacy, but also sells all manner of non-qualified goods. If the FSA participant fills his/her prescription and also proceeds to make a non-qualified purchase (e.g., a magazine or candy), and then presents an FSA debit-card for payment, there is a high likelihood that the entire amount will be posted to the participant's FSA, and the funds will be disbursed for both the qualifying and non-qualifying expenditure. Posting non-qualified expenses to a participant's FSA is a violation of the Internal Revenue Code and represent a significant risk for companies/employers to assume.

Other elements of current adjudication processes may include: reliance upon the participant to only make qualified purchase; reliance upon the merchant to ring-up qualified and non-qualified purchases separately; an evaluation of the account fund balance (to prevent excess charges); an evaluation of the eligibility status of the cardholder (to make sure they are still employed); and verifying the transaction amount to check if it corresponds to a “typical” co-pay amount. Unfortunately, none of these screening elements will prevent the posting of some non-qualified expenses to the participant's FSA.

The penalties for posting non-qualified expenses to an FSA, either willfully or inadvertently, are relatively severe for both the program sponsor and the FSA participants. For example, if the IRS determines that the FSA program is not in compliance with the rules of Section 125, one outcome is that all of the participants would be deemed to be in constructive receipt of the amounts they each contributed to their FSA. These amounts would therefore be subject to tax and penalty and could potentially apply to all contributions to the Section 125 plan, not just the medical plan contributions.

Also, the employer would be liable for tax, penalty and interest for failure to withhold the tax that was due on the amounts of income that are treated as constructively received. Penalties and interest for not reporting the amounts deemed to be constructively received would also be incurred. There are a wide range of penalties for failure to report and failure to withhold which include everything from criminal penalties if the failure is found to be “willful” (IRC Section 7202, 7203 and 7204) to significant civil monetary penalties (IRC 6651, 6656, 6672, 6674, 6721-6724).

The risks associated with posting non-qualified transactions to an FSA are often seen as untenable, even in light of the financial benefits available to both employers and individual employees. Therefore, a method and system of adjudication that would provide all the conveniences of a debit-card transaction and simultaneously maintain compliance (and reduce or eliminate these risks) would be desirable. By reducing the risk associated with non-compliance, more employers may be able to offer debit-cards to their employees, participation by employees would increase, and employers could take full advantage of the financial benefits (e.g., reduced payroll tax payments) that are available through FSA's.

### SUMMARY OF THE INVENTION

An FSA debit-card system and method of adjudication that substantially eliminates the paperwork component of claims processing, and assures compliance with the Internal Revenue Code and Regulations, is presented. The debit-card system provides a virtually seamless front-end transaction between the participant and the merchant/provider. The cards can be used to pay FSA qualified expenses from these types of accounts. Payment adjudication is conducted through a process that substantially eliminates the posting of non-qualified expenses and results in only qualified expenses being posted to an individual participant's FSA. Compliance is accomplished through the creation of a sponsor shadow account for each FSA program that will mirror each sponsor's group account. Individual transactions will be posted to the sponsor's shadow account pending adjudication. Upon approval as a qualified expense, the transaction will be released from the sponsor's shadow account and posted to the individual participant's FSA. In this way, non-qualified expenses will not be posted to the participant's FSA, thereby eliminating the risks and penalty for both plan sponsors and plan participants.

### BRIEF DESCRIPTION OF THE DRAWINGS

The features, aspects, and advantages of the present invention will become better understood with regard to the following description, appended claims, and accompanying drawings where:

FIG. 1 is a flowchart depicting a typical front-end point-of-sale FSA transaction wherein an FSA participant pays for the transaction with out-of-pocket funds.

FIG. 2 is a flowchart depicting the typical procedure for an FSA participant to request reimbursement for an FSA transaction and depicts a typical backroom process.

FIG. 3 is a flow chart depicting the typical point-of-sale FSA transaction wherein a cardholder pays for a transaction using their debit-card.

FIG. 4 is a flow chart depicting the general backroom process of adjudication as conducted under current practice wherein debit-cards are in use.

FIG. 5 is a flow chart depicting a general process for screening a debit-card transaction as a preliminary step in the adjudication method and system contemplated by one embodiment of the present invention.

FIG. 6 is a flow chart depicting a secondary step in the adjudicating method and system as contemplated by one embodiment of the present invention.

FIG. 7 is a flow chart depicting potential methods of performing the adjudication of screen transactions prior to posting to a participant's account, as contemplated by one embodiment of the present invention.

FIG. 8 is a block diagram of a system architecture for implementing the present invention.

### DETAILED DESCRIPTION

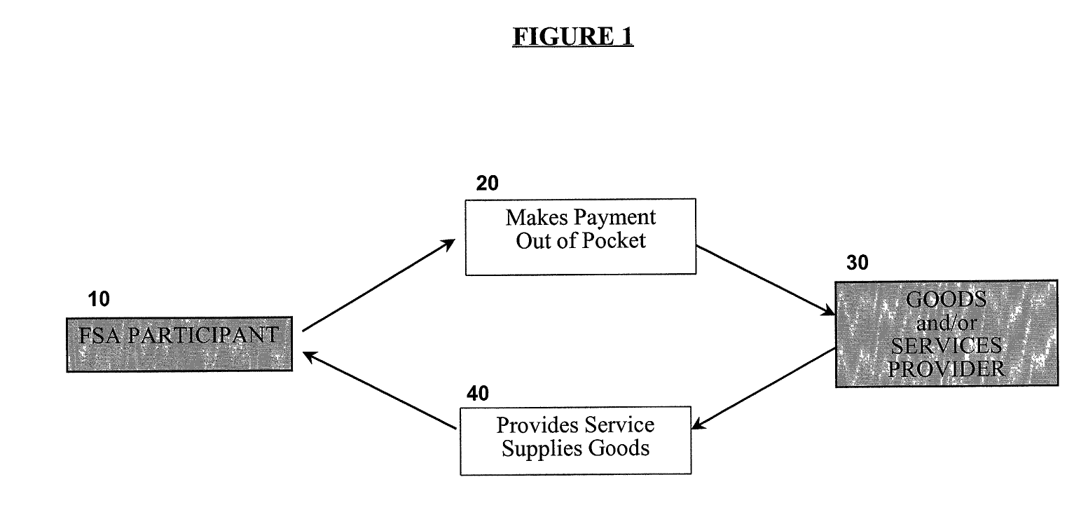

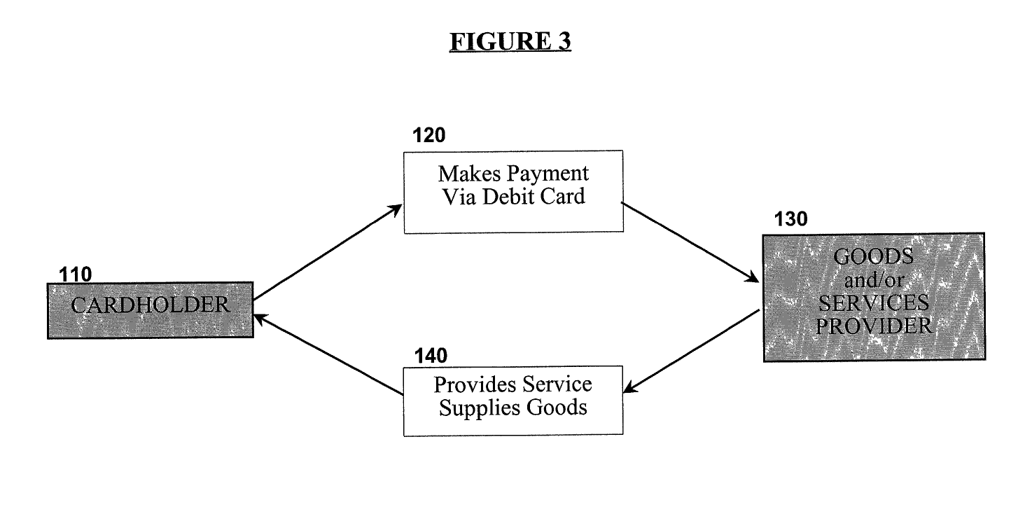

The problems described above are addressed by the pre-posting adjudication method and system of the present invention. FIG. 3 shows one example of the front-end of a transaction as contemplated by the present invention. Instead of making an out-of-pocket payment 20 as shown in FIG. 1, the cardholder 110 makes payment 120 to the provider 130 at the point-of-sale with a debit-card that is tied to the cardholder's FSA in exchange for receiving goods and/or services 140. As discussed previously, a front-end process that incorporates a debit-card tied to an FSA account substantially eliminates the paperwork hassle, but it does nothing to alleviate the risk of posting non-qualified charges to the FSA account and may, in fact, result in more non-qualified expenses being posted than traditional reimbursement processes currently allow.

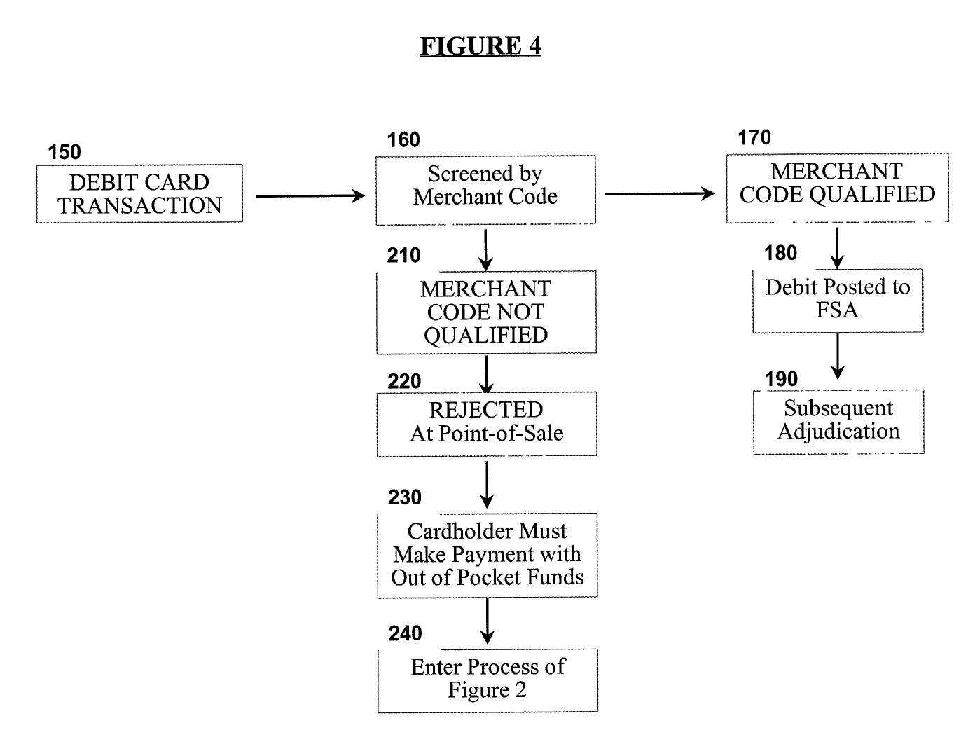

FIG. 4 depicts the current backroom process of adjudicating FSA debit-card transactions and highlights the weakness in the order of adjudication relative to posting to a participant's FSA. For example, the transaction 150 is electronically screened 160 by merchant category code. If the merchant code is qualified 170 such that it falls within a pre-selected grouping of codes, a debit is posted 180 to the cardholder's FSA. In some instances, subsequent adjudication 190 may occur (e.g., during an audit), but the process generally ends when the debit is posted 180 to the cardholder's FSA. As discussed previously, screening transactions by merchant category code is an incomplete and inadequate adjudication because non-qualified expenses can be incurred at merchants that have “qualified” merchant codes.

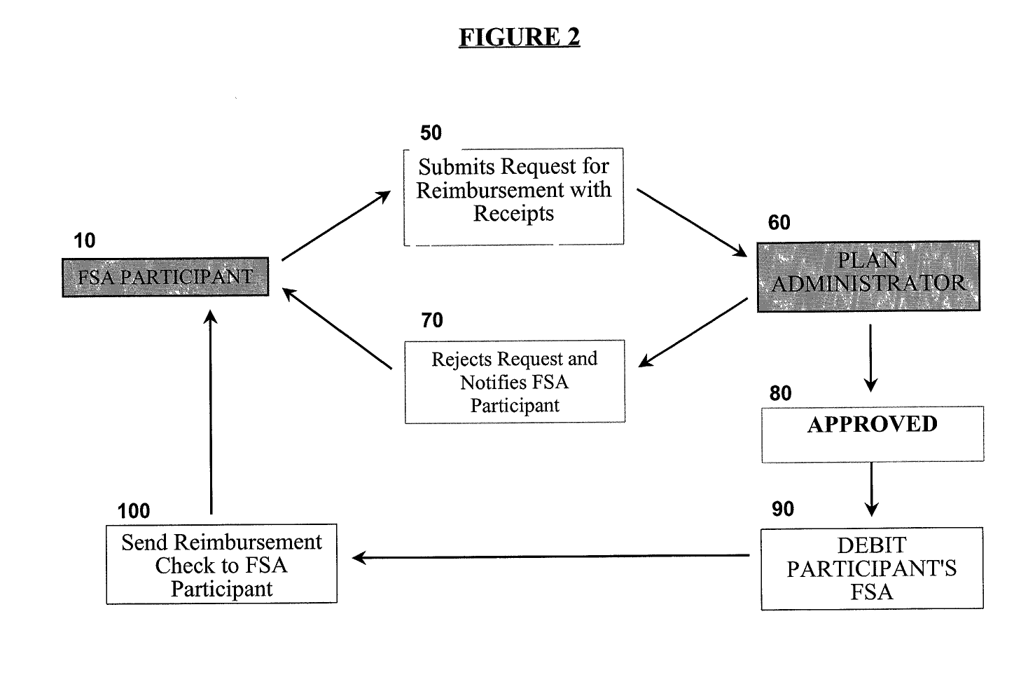

Another weakness of the current backroom process shown in FIG. 4 arises when the merchant code is not qualified 210. If this occurs, the debit-card will be rejected at the point-of-sale 220, requiring the cardholder to immediately make payment with out-of-pocket funds 230 and subsequently enter the reimbursement process 240 shown in FIG. 2. Rejection of an FSA debit-card at the point-of-sale because of a poor adjudication system and method in the backroom creates additional problems in the front-end portion of the transaction.

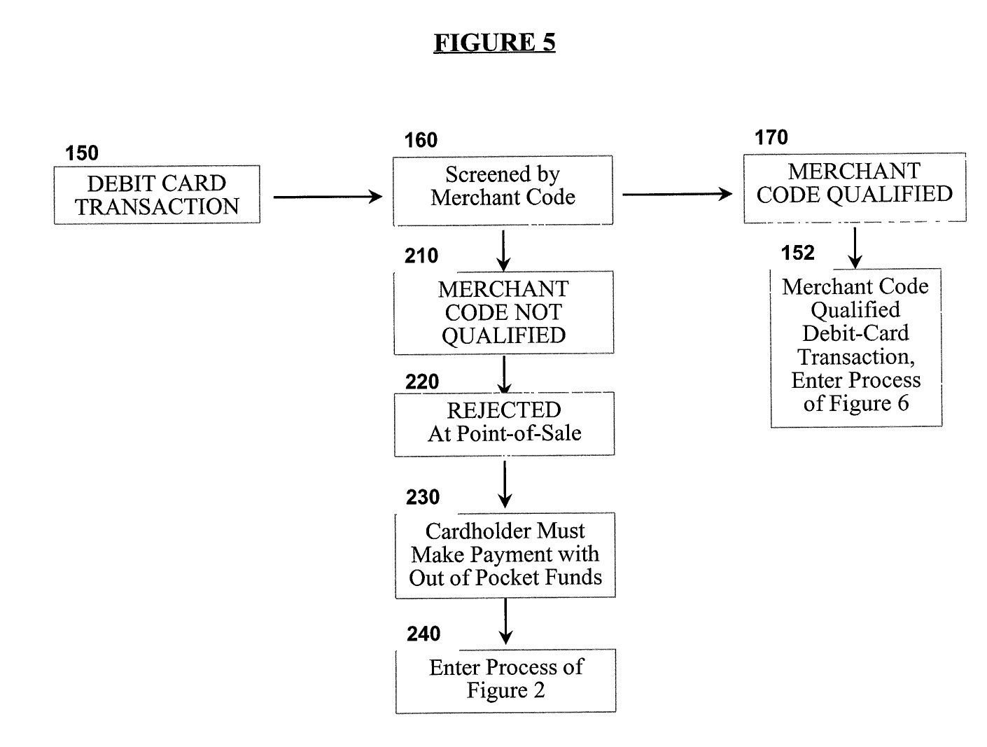

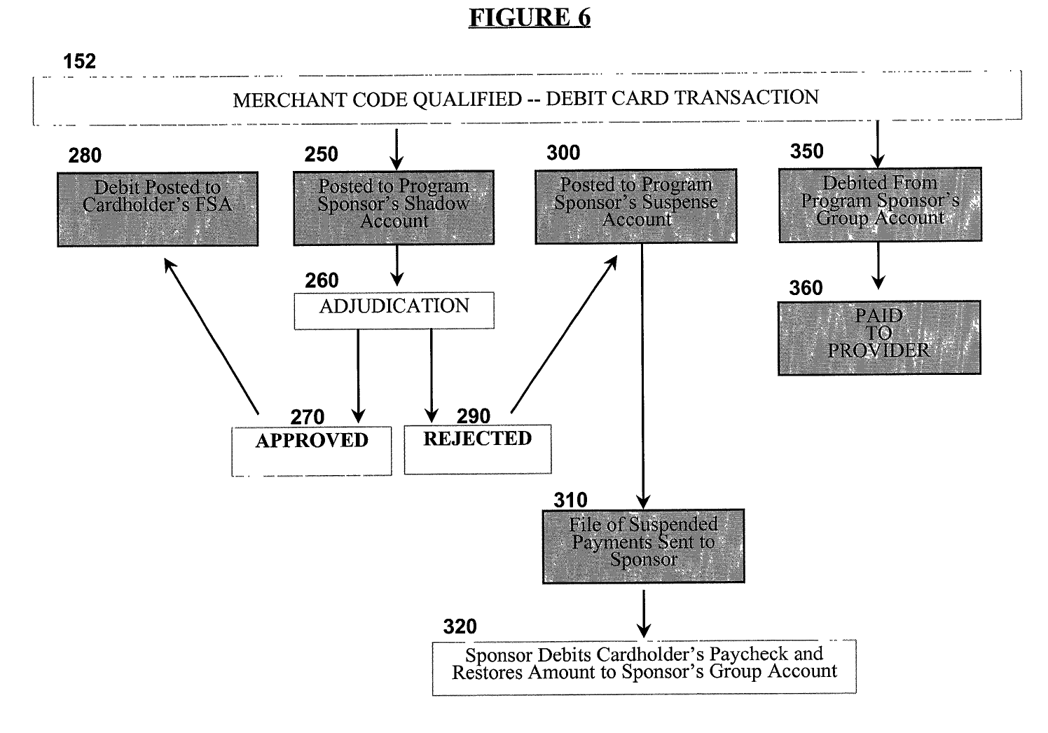

FIG. 5 shows one embodiment of the screening of a debit-card transaction as a preliminary step in an alternative adjudication process in accord with the present invention. After a debit-card transaction 150 is screened by merchant code 160 and found to be qualified 170, it then enters the process depicted in FIG. 6 (represented by 152).

FIG. 6 is an example of a backroom adjudication process in accord with the present invention. Under the method and system of the present invention, merchant code qualified transactions are not posted directly to a cardholder's FSA. The merchant code qualified debit-card transaction 152 is instead posted to the program sponsor's shadow account 250 and also debited from the program sponsor's group account 350. The amount that is debited from the program sponsor's group account 350 is paid to the goods and/or services provider 360. Subsequent to posting a transaction to the shadow account 250, and prior to posting the transaction to the cardholder's FSA 280, an adjudication process 260 (detailed below) is undertaken. If the transaction is approved 270 a debit is posted to the cardholder's FSA 280. If, upon adjudication 260 the transaction is rejected 290, a posting is made to the program sponsor's suspense account 300. In this way, a rejected transaction 290 should never be posted to a cardholder's FSA 280. Periodically, a file of suspended payments from the program sponsor's suspense account 300 is sent to the sponsor 310. Upon receiving this information, a sponsor may choose to debit cardholder's next paycheck 320 to restore the funds to the program sponsor's group account that were previously paid to the goods and/or services provider (350).

The method and system in accord with the present invention provide an FSA sponsor's shadow account (“shadow account”) that corresponds and relates to the FSA sponsor's group account. A shadow account is merely a non-funded or “paper” account that relates to the sponsor's group account. A sponsor's group account will be a funded account, for example, a corporation's demand deposit account. Transactions are posted to the shadow account and then adjudicated before posting to an individual participant's FSA. This prevents the posting of non-qualified expenses to a participant's FSA, and eliminates the possibility of a participant having to make payment at the point-of-sale with out-of-pocket funds.

As transactions occur, as contemplated by the present invention, the amount of the transaction is both debited from the FSA sponsor's group account and posted to the program shadow account pending adjudication. While adjudication is pending, the transaction amount may be placed on “hold” within the participant's FSA. The amount on “hold” would then preferably be unavailable for further disbursement until adjudication is completed. If adjudication is completed and the transaction is approved, the transaction is posted to the participant's FSA and the total amount available for future disbursement is reduced accordingly. If, upon completing adjudication, the transaction is rejected, the “hold” is removed from the participant's FSA, thereby restoring the total amount available for future disbursements, and procedures as shown in FIG. 6, for example, are initiated to restore the amount to the sponsor's group account.

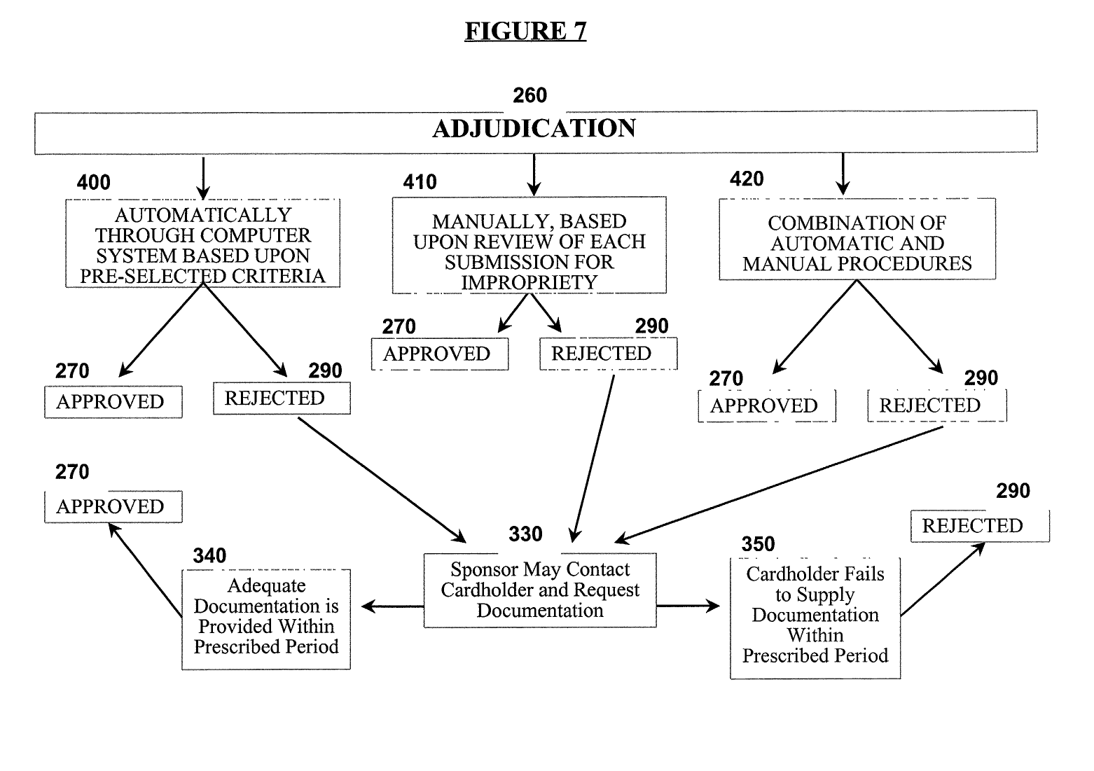

FIG. 7 shows one example of an adjudication process in accord with the present invention. When a transaction that has been previously posted to a sponsor's shadow account is subsequently submitted for adjudication 260, it may be reviewed automatically 400, manually 410 or through some combination of automatic and manual procedures 420. Manual adjudication 410, for example, may require that an individual or staff of individuals read through the detail of each transaction (or summary thereof) and pass judgment on the propriety or impropriety according to a set of criteria. Regardless of how the review is conducted, transactions that are approved 270 will be posted to the cardholder's FSA account. Transactions that are rejected 290 may result in the sponsor contacting the cardholder to request documentation 330. This contact may occur via e-mail, voicemail, or other conventional means of communication, such as a letter or telephone call. If adequate documentation is provided by the cardholder within a prescribed period 340, the transaction will be approved 270. If adequate documentation is not forthcoming 350, then the transaction is finally rejected 290.

Computerized adjudication 400 may involve, for example, receiving electronic information from a point-of-sale transaction (e.g., magnetic media reader) via telecommunication lines. The information is received by a first computer that is programmed to approve or deny the transaction based upon certain criteria. The first computer may then communicate electronically with one or more additional computers to effectuate the remaining steps of the process. For example, the amount of the transaction may be electronically communicated to a network of computers that cause funds to be transferred from the sponsor's group account to a third party service provider. Details of the transaction (including, for example, participant identifying data, provider identification data, descriptive transaction data and/or merchant category code), may be electronically communicated to a network of computers that can compare the transaction details with certain criteria to determine compliance. Descriptive transaction data may include any type or form of information indicative of transactions that are qualified FSA expenditures. For example, transactions may have additional levels of codes or descriptions.

The adjudication method and system of the present invention may use predetermined review criteria based upon, for example, merchant category codes; a database of merchants that provide only qualified goods or services; historical transaction data; typical transaction amounts; and other suitable criteria that are indicative of, and can assure that the transaction occurred with, a merchant (service provider) who provided qualified services or goods as part of the specific transaction being adjudicated. For example, merchants may have additional levels of codes or passwords assigned to them that assist in the adjudication process.

The adjudication review criteria may be customized for each FSA program or sponsor and may include, for example, IRS compliance parameters, sponsor provided parameters, and/or parameters provided by the insurance underwriter. These criteria may be either static, in that they remain constant throughout the plan year, or may be dynamic such that they are subject to periodic alteration either by the plan administrator or through other means.

A method and system for adjudicating payment from a cardholder account having a predetermined amount available for expenditure, is provided. The methodology and system incorporate a shadow account for posting cardholder transactions pending adjudication. The shadow account relates to a program sponsor's group account. The program sponsor's group account corresponds to a collection of cardholder accounts. In one preferred embodiment, the cardholder's account is a Flexible Spending Account and the program sponsor is the cardholder's employer.

The methodology and system of the present invention preferably includes the posting of a debit to the program sponsor's shadow account in an amount relating to the transactional amount of the services received by the cardholder. The methodology and system preferably include the step of adjusting the cardholder's account balance in an amount relating to the transactional amount to thereby effect the amount available for subsequent expenditure in the FSA pending final adjudication. The methodology and system preferably include a step for charging the program sponsor's group account in an amount equal to a periodic summation of debits posted to the program sponsor's shadow account. The periodic summation may occur on a regular basis (e.g., hourly, daily, weekly, etc.) or upon some other event (e.g., the running total of debits reaches a milestone amount, fiscal period ends or an audit is initiated). A step for adjudicating the qualifications of a debit that is posted to the program sponsor's shadow account is also preferably provided. Subsequent to finding that a debit previously posted to a program sponsor's shadow account was for a qualified FSA expense, the debit may be shifted from the program sponsor's shadow account and may be posted to the cardholder's FSA. The amount available for expenditure in the FSA may be adjusted accordingly as may be the amount pending adjudication in the program sponsor's shadow account.

Upon determining that a debit was expended for a non-qualified expense, the debit posting is removed from the program sponsor's shadow account and the cardholder's FSA amount available for expenditure is adjusted accordingly. A step is also preferably provided wherein the cardholder can restore the transaction amount to the program sponsor group account if said transaction is rejected upon adjudication.

A method of adjudicating payment prior to posting to a cardholder account is also provided. Upon a cardholder initiating a transaction, the amount will be posted to the corresponding sponsor's program shadow account and funds will be disbursed from the sponsor's group settlement account. The amount available for expenditure in the cardholder's FSA will be placed on temporary hold, and the goods or services of the underlying transaction will be submitted to an adjudication process, wherein upon a determination that the goods and/or services were in compliance with pre-selected criteria (i.e., qualified medical expenses), the amount available for expenditure in the cardholder FSA is debited.

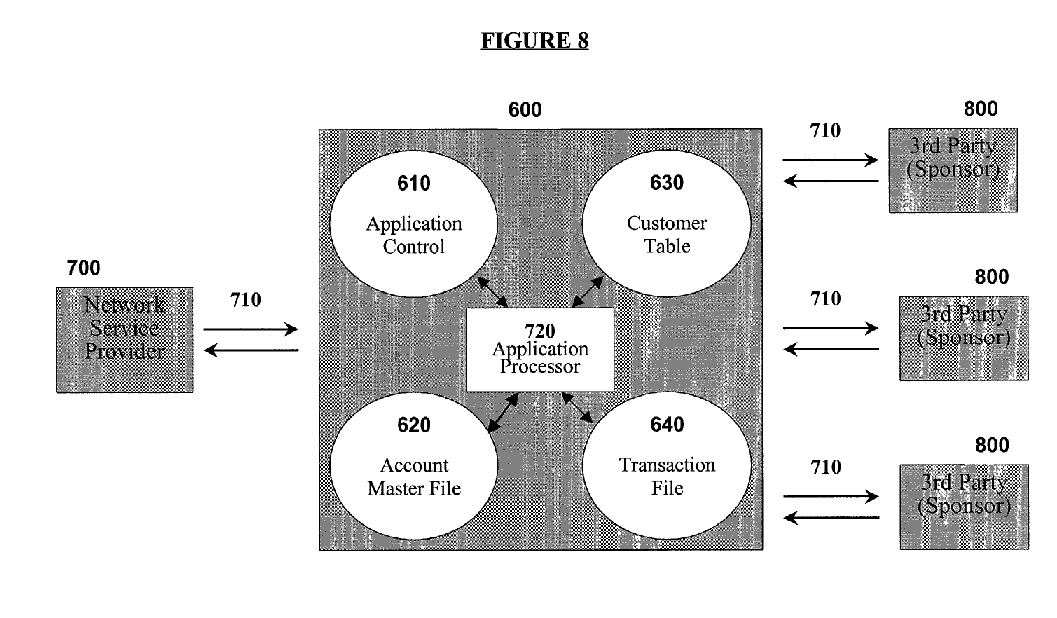

With reference to FIG. 8, the adjudication method and system may be facilitated either completely, or in large part, by the exemplary hardware configuration. FIG. 8 includes one or more network service providers 700, one or more third party computers (plan sponsors) 800 and the adjudication computer network 600. These various entities are typically in electronic communication with each other via a two-way communications network 710 such as the Internet, an EDI interface, FTP, RJE dial-up and/or direct connect. These communications networks 710 facilitate the flow of electronic information to and from the adjudication computer network 600.

The third party computers 800 represent the sponsors of the FSA plans. The third parties 800 may be the employers of the plan participants, or the third parties 800 may be an outsourced overseer of a specific FSA plan. These third party systems 800 typically include one or more computers and other electronic hardware and/or software that enable the third party to set up, track, and administer the specific accounts of the sponsor's plan participants. Each of the third parties 800 represent a different FSA plan or provider of an FSA plan. The third parties 800 are typically in electronic communication 710 with the adjudication computer network 600 to facilitate communication from the plan sponsor 800 to the adjudication computer network 600 (e.g., to set up the account) and from the adjudication computer network 600 to the plan sponsor 800 (e.g., to instruct the plan sponsor to update a participant's FSA after adjudication).

To facilitate the use of a debit-card in accord with the present adjudication system, the adjudication computer network 600 is also in communication 710 with a network service provider 700. The network service provider 700 typically provides access to a debit-card network and provides services related to debit-card use. For example, once the plan sponsor 800 provides information about the participants of its FSA plan to the adjudication computer network 600, the adjudication computer may provide the relevant information to the network service provider 700 so the network service provider can create debit-card based accounts for the plan participants. The network service provider 700 may then create the actual debit-cards, mail the cards to the plan participants and further setup the participants' accounts. When a participant uses the debit-card to make a point-of-sale transaction, the network service provider 700 oversees and logs the transaction. Periodically, for example on a daily basis, the log of transactions may be sent from the network service provider 700 to the adjudication computer network 600 for final adjudication. In this way, the network service provider 700 acts as an outside entity that facilitates the debit-card transactions.

The adjudication computer network 600 determines the proper FSA accounting (performs transaction adjudication) based upon, for example, the information received from the network service provider 700 and the third parties 800. The adjudication computer network 600 typically includes one or more computers that contain databases to store information and application processors to carry out functions. For example, the adjudication network computer 600 may be a mainframe computer that includes an application processor 720 (which may include a microprocessor, memory and/or storage, all of which are programmed to carry out specific functionality), an application control database 610, an account master file database 620, a customer table database 630 and a transaction file database 640. The application processor 720 manipulates the information contained within these databases 610, 620, 630, 640 to provide functionality to the system (e.g., setting up and administering sponsor group accounts, setting up and administering sponsor shadow accounts, and adjudicating transactions).

The above hardware configuration and information interactions were provided by way of example only and should not be used to limit the scope of the present invention. An almost limitless array and orientation of components and databases could be used with the present invention. Any single computer configuration may be carried out on multiple computers, and multiple computer systems could be combined into one system. All computer-related components described are interchangeable as is commonly known in the computer arts.

While specific embodiments and methods for practicing this invention have been described in detail, those skilled in the art will recognize various manifestations and details that could be developed in light of the overall teachings herein. Accordingly, the particular arrangements disclosed are meant to be illustrative only.

What is claimed is:

1. A method of adjudicating a transaction for payment from a participant account, said participant account having an amount available for expenditure, comprising:
initiating a transaction, said transaction having a value;
screening said transaction based upon a first set of criteria;
posting an amount relating to said value to a holding account;
reducing the amount available for expenditure in the participant account; and,
adjudicating said transaction, wherein upon approval of the transaction, said amount posted to the holding account is released and posted to the participant account and the amount available for expenditure is reduced.

2. The method of claim 1 wherein the participant account is a Flexible Spending Account.

3. The method of claim 1 wherein the amount available for expenditure is pre-determined.

4. The method of claim 1 wherein the transaction comprises an exchange of payment for qualified medical expense.

5. The method of claim 1 wherein the initiating step is a point-of-sale purchase with a debit-card.

6. The method of claim 1 wherein the holding account is a sponsor shadow account.

7. The method of claim 1 wherein said adjudicating step utilizes pre-selected criteria.

8. The method of claim 7 wherein approval of the transaction is based upon the transaction complying with said pre-selected criteria.

9. The method of claim 1 further comprising after the adjudicating step, payment of the amount posted to the participant account to a sponsor group account.

10. The method of claim 1 wherein the adjudicating step further comprises, upon rejection of the transaction, said amount posted to the holding account is released and posted to a sponsor suspense account and the amount available for expenditure in the participant account is restored.

11. The method of claim 1 wherein said first set of criteria includes merchant category codes.

12. The method of claim 5, wherein said debit-card is tied to said participant account.

13. A method of adjudicating a transaction prior to posting said transaction to a participant's flexible spending account comprising:
initiating a transaction, wherein the participant receives goods or services from a provider;
screening said transaction by a merchant category code associated with said provider;
determining said merchant category code to be qualified;
paying said provider from a sponsor group account, said sponsor group account relating to a plurality of participant flexible spending accounts;
posting said transaction to a sponsor shadow account;
submitting said transaction to adjudication;
adjudicating said transaction approved; and
posting said transaction to the participant's flexible spending account.

14. The method of claim 13, wherein said transaction is comprised of participant identifying data, provider identifying data, a transactional amount, and transactional descriptive data.

15. The method of claim 14, wherein said transactional descriptive data includes sufficient information to determine if the transaction was for a qualified medical expense.

16. A system for adjudicating payment from a participant cardholder's account, comprising:
an application processor, wherein said application processor is adapted to send electronic communications to and receive electronic communications from at least one network service provider and at least one third party processor; and
at least one database in electronic communication with said application processor, wherein said at least one database includes information corresponding to a sponsor group account and information corresponding to a sponsor shadow account.

17. The system of claim 16, wherein said application processor is adapted to adjudicate a received transaction request, further wherein said application processor is adapted to update said information corresponding to a program sponsor shadow account prior to adjudication.

18. The system of claim 16, wherein said application processor is adapted to initiate sponsor accounts responsive to communications received from said at least one third party processor.

19. The system of claim 16, wherein said third party processor is a computer associated with a qualified medical service provider.

20. The system of claim 16, wherein said network service provider is a debit-card service host.

21. The system of claim 16, wherein said application processor and said at least one database are a part of a mainframe computer.

22. The system of claim 16, wherein said electronic communications to and from said at least one network service provider and said at least one third party processor utilize a communications methodology selected from the group consisting of: the internet; RJE dial-up; FTP; EDI; and Direct Connect.

23. A system for adjudicating payment from a participant cardholder account having an amount available for expenditure prior to debiting the participant account, comprising:
a program sponsor group account corresponding to a plurality of participant accounts;
a program sponsor shadow account corresponding to said program sponsor group account;
means for posting a debit to the program sponsor shadow account in an amount relating to a transactional value of services provided to said participant by a service provider;
means for adjusting the amount available for expenditure in the participant account in an amount relating to the transactional value such that the amount available for expenditure in the participant account is unavailable for subsequent expenditure pending adjudication;
means for debiting the program sponsor group account in an amount equal to a summation of debits posted to the plurality of participant accounts;
means for paying the service provider for services provided to the participant;
means for reviewing the debit to the in the participant account for adjudication, wherein upon a finding of propriety, the debit is posted to the participant account and the amount available for expenditure in the participant account is adjusted accordingly; and
means for reviewing the debit to the in the participant account for adjudication, wherein upon a finding of impropriety the amount available for expenditure in the participant account is adjusted accordingly and the debit previously posted to the program sponsor group account is restored.
